(19) United States
(12) Patent Application Publication
(10) Pub. No.: US 2025/0324220 A1
(43) Pub. Date: Oct. 16, 2025

(54) DYNAMIC HAZARD PRIORITIZATION SYSTEM

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/635,998

(22) Filed: Apr. 15, 2024

(51) Int. Cl. H04W 4/021; G06F 3/04847; G06V 20/52; H04W 4/90

(52) U.S. Cl. CPC H04W 4/021; G06F 3/04847; G06V 20/52; H04W 4/90

(57) ABSTRACT

The technology discloses a method for generating a prioritized queue containing reported safety hazards in a site. The system receives a message with at least one issue within the site, and the system generates a command set containing the message and other instructive parameters. The system inputs the command set in an AI model, which identifies issue(s) within the message and integrates the issue(s) in a prioritized queue. Determining where each issue is integrated into the prioritized queue is directed by the instructive parameters in the command set. The system receives the generated prioritized queue from the AI model, in which the system presents to a safety user device.

### TECHNICAL FIELD

The present disclosure is generally related to wireless communication handsets and systems.

### BACKGROUND

Artificial intelligence (AI) models often operate based on extensive and enormous training models. The models include a multiplicity of inputs and how each should be handled. Then, when the model receives a new input, the model produces an output based on patterns determined from the data the model was trained on.

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity. Existing safety reporting procedures often involve manually reviewing and prioritizing individual submissions and reports by safety personnel.

### BRIEF DESCRIPTION OF THE DRAWINGS

FIG. 1 is a block diagram illustrating an example architecture for an apparatus for device communication and tracking, in accordance with one or more embodiments.

FIG. 2 is a block diagram illustrating an example apparatus for device communication and tracking, in accordance with one or more embodiments.

FIG. 3 is a block diagram illustrating an example charging station for apparatuses implementing device communication and tracking, in accordance with one or more embodiments.

FIG. 4A is a block diagram illustrating an example environment for apparatuses and communication networks for device communication and tracking, in accordance with one or more embodiments.

FIG. 4B is a flow diagram illustrating an example process for generating a work experience profile, in accordance with one or more embodiments.

FIG. 5 is a block diagram illustrating an example facility using apparatuses and communication networks for device communication and tracking, in accordance with one or more embodiments.

FIG. 6 illustrates an example of a worksite that includes a plurality of geofenced areas, in accordance with one or more embodiments.

FIG. 7 is a block diagram illustrating a dynamic hazard prioritization system, in accordance with one or more embodiments.

FIG. 8 is a block diagram illustrating the dynamic hazard prioritization system creating a priority queue for received issues, in accordance with one or more embodiments.

FIG. 9 is a flow diagram illustrating a method for creating a priority queue, in accordance with one or more embodiments.

FIG. 10 is a block diagram illustrating creating a command set to operate as input into an AI model, in accordance with one or more embodiments.

FIG. 11 is a block diagram illustrating initiating a communication channel between two safety user devices in response to reporting an issue, in accordance with one or more embodiments.

FIG. 12 is a block diagram illustrating a tiered system of safety hazards, in accordance with one or more embodiments.

FIG. 13 is a block diagram illustrating notifying other users within the surrounding area of a safety hazard, in accordance with one or more embodiments.

FIG. 14 is a block diagram illustrating a service profile, in accordance with one or more embodiments.

FIG. 15 is a block diagram illustrating using predefined prompts to create the command set, in accordance with one or more embodiments.

FIG. 16 is a block diagram illustrating an example computer system, in accordance with one or more embodiments.

FIG. 17 is a high-level block diagram illustrating an example AI system, in accordance with one or more embodiments.

### DETAILED DESCRIPTION

In industrial and organizational settings, the identification and management of safety hazards and other issues are needed to maintain a secure and healthy work environment. A wide array of potential hazards can occur, ranging from more severe physical dangers such as machinery malfunctions, electrical hazards, and chemical exposures to less severe dangers such as ergonomic risks or inconveniencing machine breakdowns. The consequences of neglecting more urgent safety hazards can be severe, ranging from minor injuries and productivity losses to accidents with lasting repercussions for individuals, organizations, and communities. Moreover, regulatory bodies and industry standards increasingly mandate safety protocols and compliance measures to mitigate risks and prevent accidents. Non-compliance with these regulations not only exposes organizations to legal liabilities and financial penalties but also undermines the organization's reputation and credibility. Organizations that prioritize safety additionally increase the organization's attractiveness to potential employees, customers, and investors.

However, existing processes for reporting and addressing safety concerns often suffer from inefficiencies, lack of prioritization, and inadequate oversight. For example, traditional methods typically involve manual reporting mechanisms where individuals fill out paperwork to document and report safety hazards, which are then submitted to safety personnel for review. Once submitted, the reports are relegated to the inbox of a designated safety officer responsible for the entire site. However, the manual process introduces significant bottlenecks and shortcomings.

First, the reliance on paper-based reporting leads to delays in hazard identification and resolution. Safety officers are burdened with sifting through stacks of paperwork to locate and address reported hazards, which results in a cumbersome and time-consuming process. The inefficiency not only prolongs the exposure of personnel to potential safety risks but also undermines the overall effectiveness of safety management protocols. Additionally, the absence of a systematic method for prioritizing safety hazards exacerbates the problem. Without clear guidelines or frameworks for assessing the severity and urgency of reported hazards, safety personnel resort to ad-hoc methods of prioritization, often influenced by subjective factors such as the volume of the individual or the persistence of complaints. Consequently, critical safety issues may be overlooked or deprioritized in favor of more vocal or persistent concerns, compromising the overall safety of the work environment.

The dynamic hazard prioritization system facilitates the reporting, assessment, and resolution of safety concerns. Rather than needing safety personnel to manually gather and prioritize each issue, users can submit reports of safety hazards through a user device (e.g., a safety user device). Upon submission, the system dynamically constructs a command set tailored to the specific report. The command set operates as an input in an artificial intelligence (AI) model, which the system directs to assign corresponding priority levels to each issue, which can vary based on the site the hazard is located in. The system ensures that more severe safety concerns are promptly addressed while less urgent matters are appropriately managed. The dynamic hazard prioritization system is able to prioritize hazards objectively and transparently, eliminating the subjective biases and inefficiencies that often occur in manual processes.

For example, an employee notices a leak in a chemical storage tank, posing a potential safety hazard due to the risk of chemical exposure and environmental contamination. The employee uses a safety user device to report the chemical leak by taking a picture and providing supplemental text with details such as the location of the storage tank, the type of chemical involved, and the size of the leak. Upon submission, the system dynamically constructs a command set including the picture, the text, and instructive parameters that direct an AI model in assigning a priority level to the hazard (e.g., the type of facility, predefined priority levels of certain hazards, the categorization geofence the hazard is located in). Subsequently, the command set is fed into the AI model, which the system directs to assign an appropriate priority level for the chemical leak. Based on the assignment, the system prioritizes the chemical leak as a high-severity issue requiring immediate attention, integrating the issue at the top of the priority queue. The dynamic hazard prioritization system enables organizations to identify and address safety hazards in a more efficient manner, which minimizes the risk of accidents, injuries, and environmental damage within the workplace.

Mobile radio devices (e.g., smart radios, safety user devices) can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees' strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

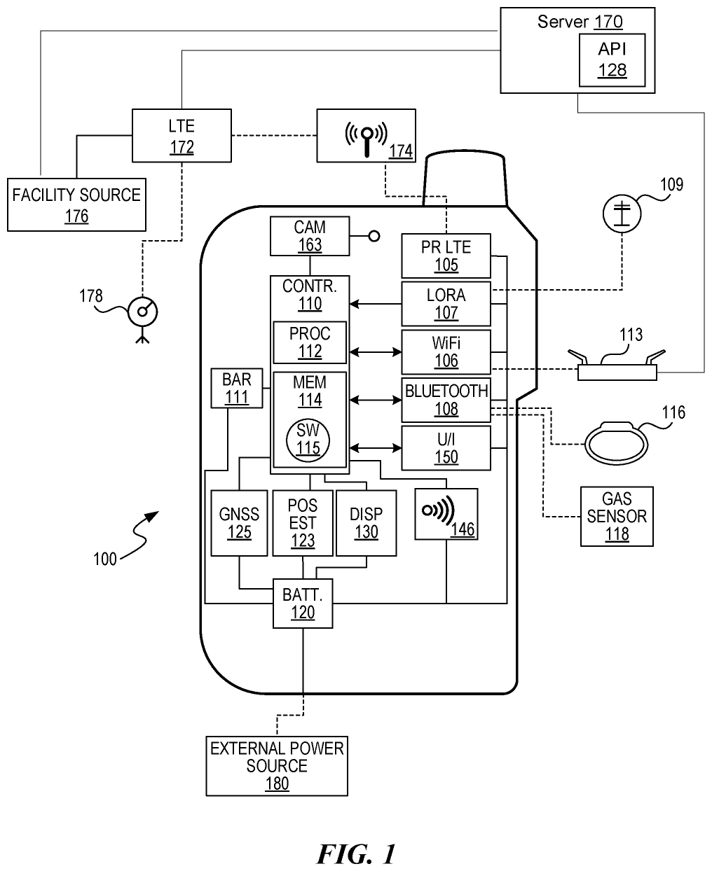

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

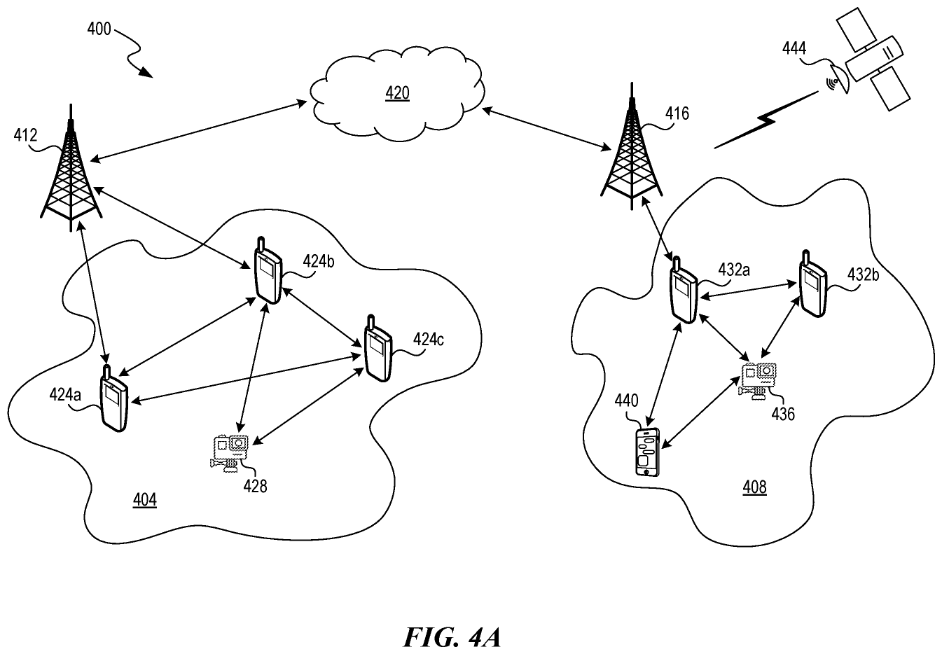

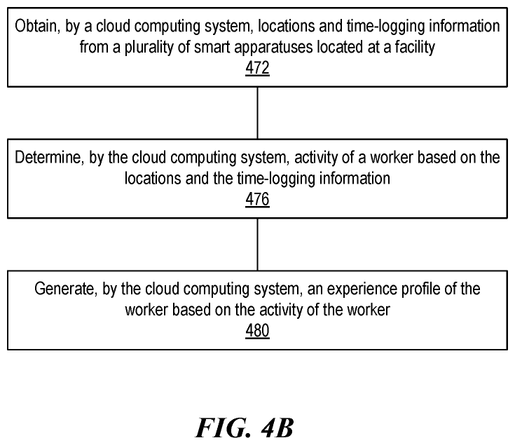

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100 (e.g., local network 404 illustrated in FIG. 4A). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Gisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The apparatus 100 communicates with a host server 170 which includes API software 128. The apparatus 100 communicates with the host server 170 via the Internet using pathways such as the Wi-Fi subsystem 106 through an access point 113 and/or the wireless antenna 174. The API 128 communicates with onboard software 115 to execute features disclosed herein.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

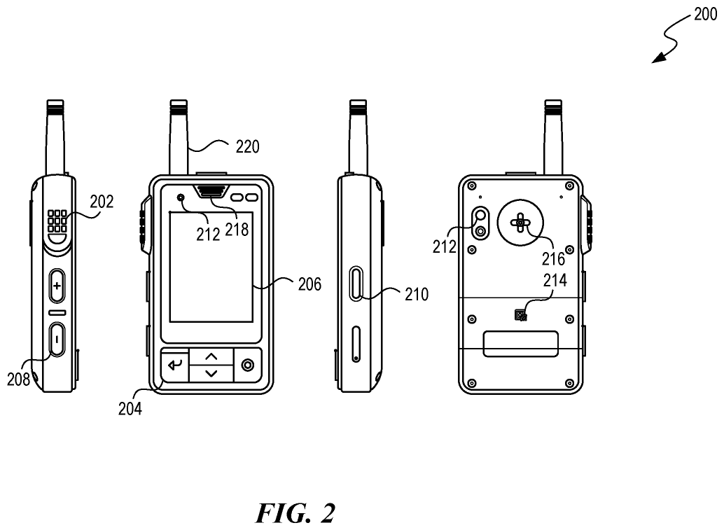

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a workers badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

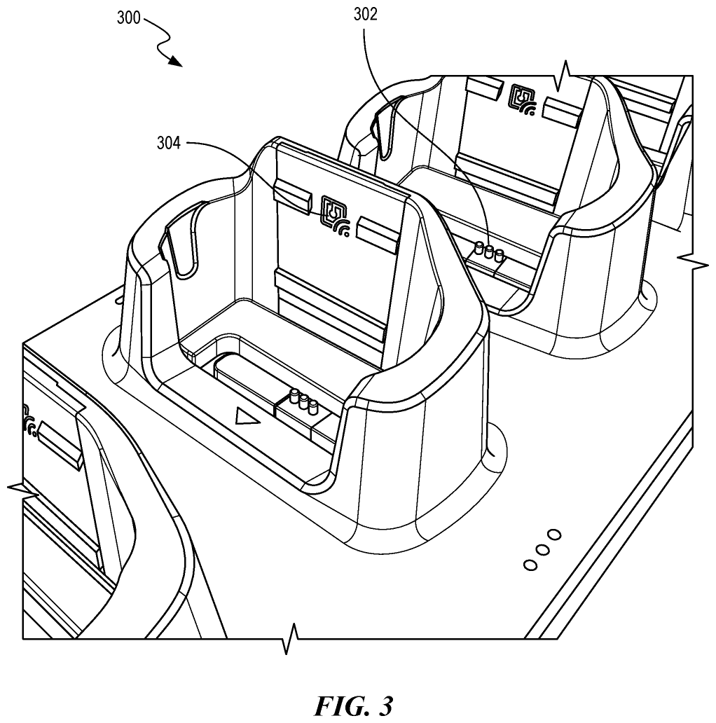

FIG. 3 is a drawing illustrating an example charging station 300 for apparatuses implementing device communication and tracking, in accordance with one or more embodiments. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

FIG. 4A is a drawing illustrating an example environment 400 for apparatuses and communication networks for device communication and tracking, in accordance with one or more embodiments. The environment 400 includes a cloud computing system 420, cellular transmission towers 412, 416, and local networks 404, 408. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, T-Mobile™, or Sprint™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio's speaker.

For example, the smart radio 424a broadcasts voice data using radio signals. Any other smart radio 424b within a range limit (e.g., 1 mile, 2 miles, etc.) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VoIP), Voice over Wi-Fi (VoWiFi), or Voice over Long-Term Evolution (VoLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services-including servers, storage, databases, networking, software, analytics, and intelligence-over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on- or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver's distance from multiple transmitters, the receiver's position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices share their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it's located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 424b can be improved by augmenting the primary location estimate with the secondary location estimate.

In some implementations, the location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

At 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

At 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

At 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn™, Monster™, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

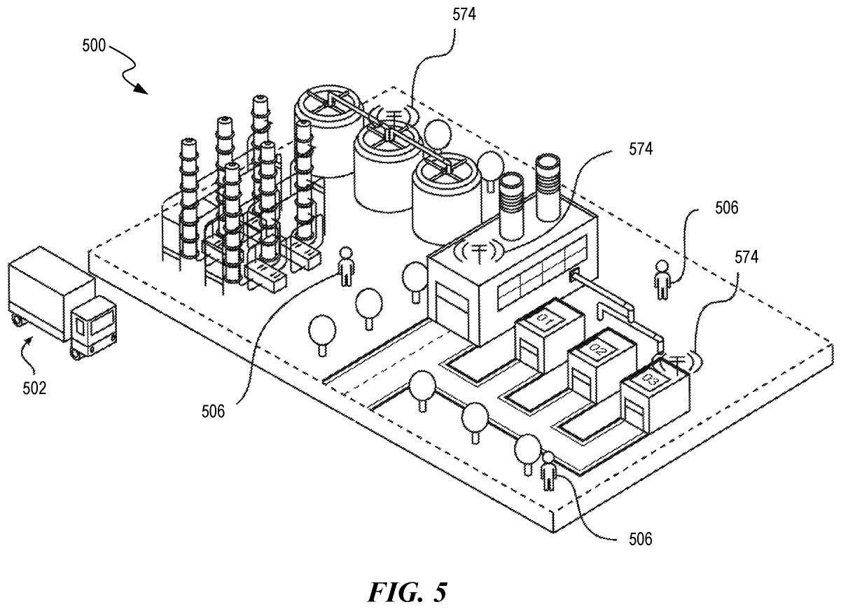

FIG. 5 is a drawing illustrating an example facility 500 using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas' directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHz) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

According to some embodiments, locations of smart radios are monitored such that at a point in time, each smart radio located in a specific geofenced area is identified.

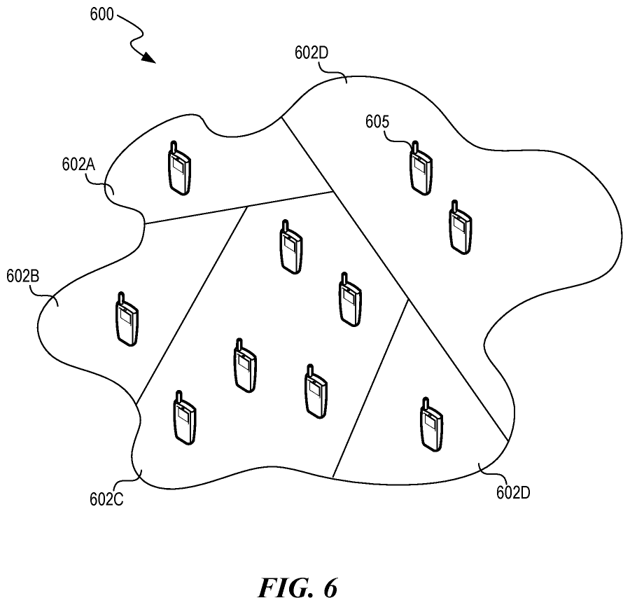

FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the plurality of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### Dynamic Hazard Prioritization System

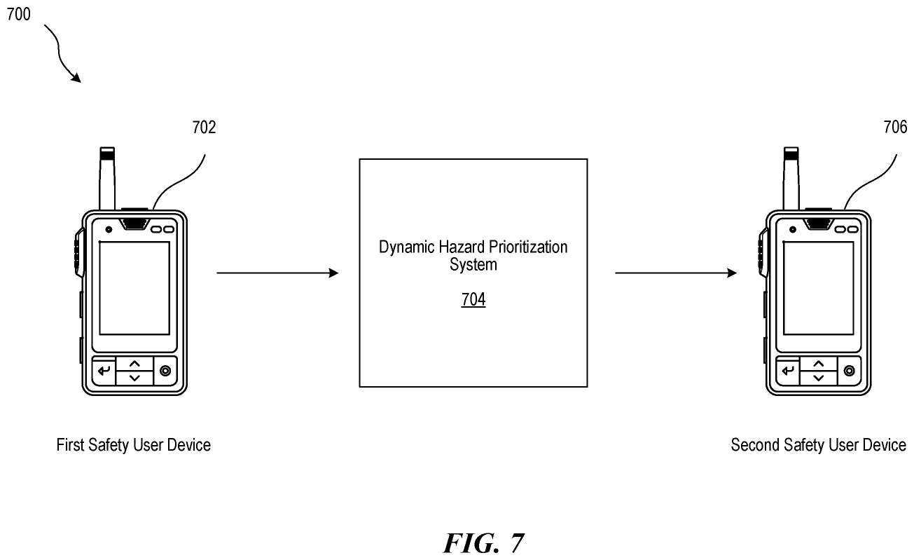

FIG. 7 is a block diagram 700 illustrating a dynamic hazard prioritization system, in accordance with one or more embodiments.

First safety user device 702 (e.g., apparatus 100, apparatus 200) serves as the primary interface through which users submit reports of safety hazards encountered in the workplace. In some embodiments, employees initiate the reporting process by accessing the dedicated safety reporting application installed on their device or by launching a designated reporting interface accessible via a web browser. Users are prompted, in some embodiments, to upload accompanying multimedia files to accompany other submitted information, such as photographs, videos, and/or text, to provide documentation and further context of the hazard.

Upon receiving a report from the first safety user device 702, the dynamic hazard prioritization system 704 evaluates the reported safety hazards to identify key attributes and contextual information that help facilitate prioritization. The dynamic hazard prioritization system 704 generates a command set (e.g., prompt, query) to direct an AI model to prioritize the corresponding issues.

Once the issues in the submitted report have been assigned a priority level and the prioritized queue has been created, the dynamic hazard prioritization system 704 communicates the prioritized queue to the second safety user device 706. The second safety user device 706 is, in some embodiments, apparatus 100 and/or apparatus 200. The user of the second safety user device 706 (e.g., safety personnel) is able to use the prioritized queue to triage all of the received reports by importance, which, in some embodiments, is defined by severity, time of resolution, number of days open, etc.

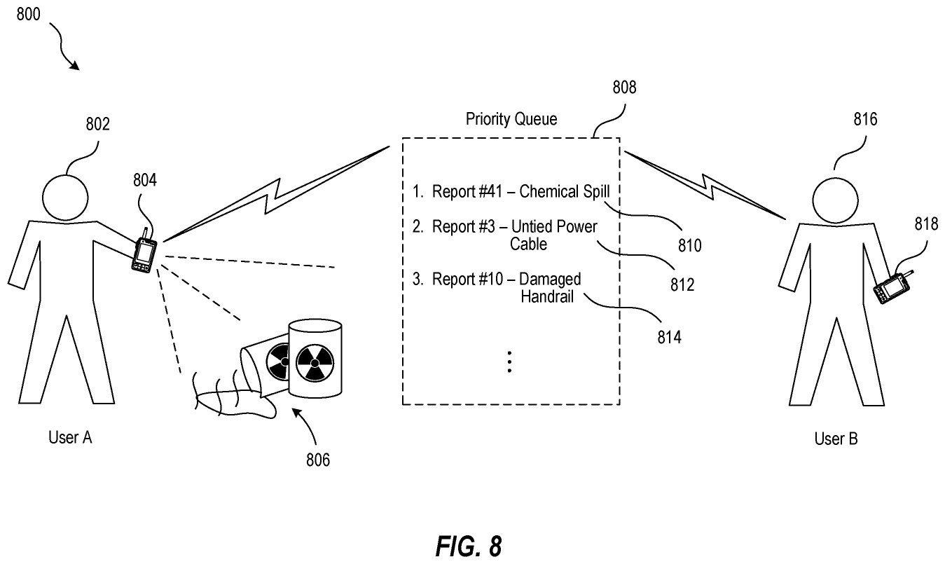

FIG. 8 is a block diagram 800 illustrating the dynamic hazard prioritization system creating a priority queue for received issues, in accordance with one or more embodiments.

User A 802 uses a safety user device 804 to capture an image of a safety hazard 806 encountered within a site (e.g., workplace, geofenced area). For example, user A 802 uses a handheld safety device, such as device 804, that is attachable to user A 802, and enables user A 802 to capture visual evidence of safety concerns or other issues while working in potentially hazardous conditions. In some embodiments, the safety user device 804 remotely captures images of safety hazards in hard-to-reach or inaccessible areas within a site or workplace (e.g., via a drone).

As user A 802 captures the image of the safety hazard, the dynamic hazard prioritization system initiates a process to evaluate and integrate the reported issue within a priority queue 808. The dynamic hazard prioritization system uses, in some embodiments, machine learning algorithms or computer vision technology to analyze the captured image in real-time to automatically identify and classify the nature and severity of the safety hazard. For example, the system preprocesses the image to enhance the image's quality and extract relevant features (e.g., noise reduction, image normalization, feature extraction). The system then applies trained machine learning models (e.g., convolutional neural networks, other image recognition models) to recognize patterns and features indicative of different types of safety hazards. The machine learning model(s) process the image data layer by layer to recognize different aspects of the safety hazard, such as the image shape, color, texture, and context. The model(s) compare extracted features against learned patterns to automatically identify and classify the nature of the safety hazard (e.g., chemical spill, fire, or machinery malfunction).

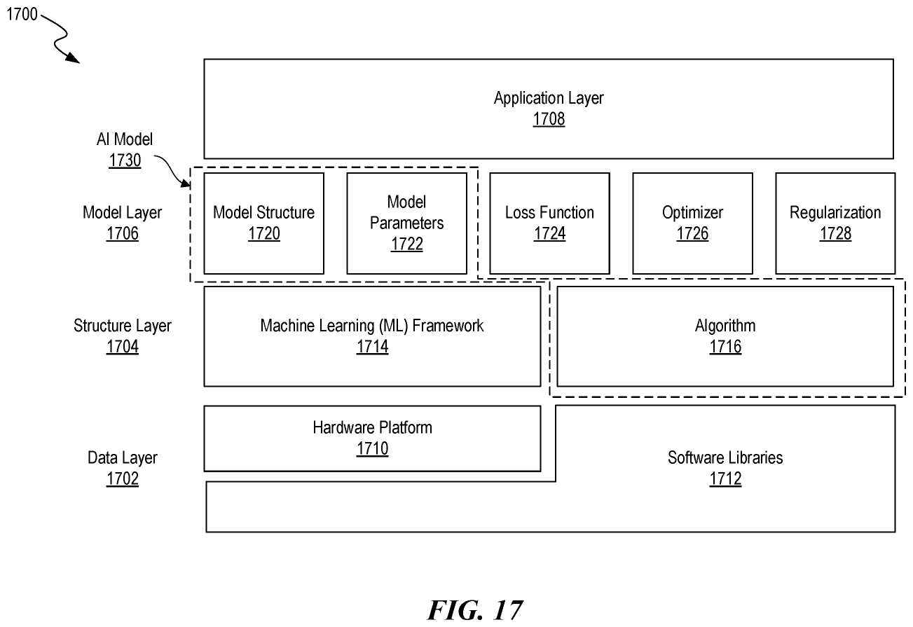

In some embodiments, the dynamic hazard prioritization system integrates natural language processing (NLP) capabilities (e.g., via a language model using a deep neural network such as a DNN, as further described in FIG. 17) to interpret any accompanying text or descriptions provided by user A 802 to aid in the contextual understanding and prioritization of the reported issue. In some embodiments, the dynamic hazard prioritization system leverages historical data or predefined rulesets to determine the appropriate priority level for the reported safety hazard, considering factors such as the type of hazard, the hazard's location, and/or past incident trends. In some embodiments, the dynamic hazard prioritization system accepts further instructive user input, where safety personnel are able to manually review and confirm the prioritization of the reported issue before adding the report to the priority queue for further action.

With the analysis complete, the dynamic hazard prioritization system integrates the safety hazard 806 into the priority queue 808. The priority queue 808 is a dynamic list that ranks each present issue or safety hazard by predetermined factors (e.g., severity, urgency). The dynamic hazard prioritization system dynamically updates the priority queue 808 as new safety hazards are reported or as existing hazards are resolved, ensuring real-time visibility into the priority queue 808. In some embodiments, each safety hazard is represented within the priority queue 808 by distinct indicators, denoting different types of hazards, a report identification indicator, and/or the hazards' respective priority levels to help users discern between issues. For example, the safety hazard 806, a chemical spill, is represented by indicator 810. The chemical spill is determined by the system to be more of a priority than an untied power cable and a damaged handrail, so even if the report for the chemical spill was sent after that of the untied power cable and the damaged handrail, the safety personnel would address the chemical spill first. In some embodiments, there are multiple indicators indicating multiple hazards (e.g., indicator 812, indicator 814).

In some embodiments, the priority queue 808 undergoes periodic reviews and adjustments based on evolving risk assessments and organizational priorities to ensure that the priority queue 808 continues to align with user preferences. In some embodiments, the priority queue 808 reflects different categorizations or classifications of safety hazards that provide, for example, tailored prioritization criteria based on specific industry standards and/or regulatory requirements. For example, any category of safety hazards involving chemicals is automatically placed higher in a queue than damaged equipment.

Once the reported safety hazard 806 is integrated into the priority queue 808, the dynamic hazard prioritization system transmits the priority queue 808 to user B 816 through the safety user device 818. In some embodiments, the dynamic hazard prioritization system transmits the priority queue 808 to user B 816 through alternative communication channels, such as email notifications or mobile application alerts, ensuring timely access to safety insights. User B 816, using the prioritized queue 808, then receives insights into the safety landscape of the workplace and is able to triage and address safety hazards with efficiency. User B 816 is able to navigate through the reported issues and prioritize response efforts based on the priority level of each hazard. In some embodiments, user B 816 receives the prioritized queue 808 not only through the safety user device 818 but also through other compatible devices or platforms, providing flexibility in accessing safety information. For example, a specialized safety management software or dashboard interface includes the priority queue 808, which allows for customized views and additional analytical tools to aid in hazard assessment and response planning. In some embodiments, user B's 816 access to the prioritized queue 808 is role-based, with different levels of authorization and permissions granted based on their responsibilities within the organization's safety management hierarchy.

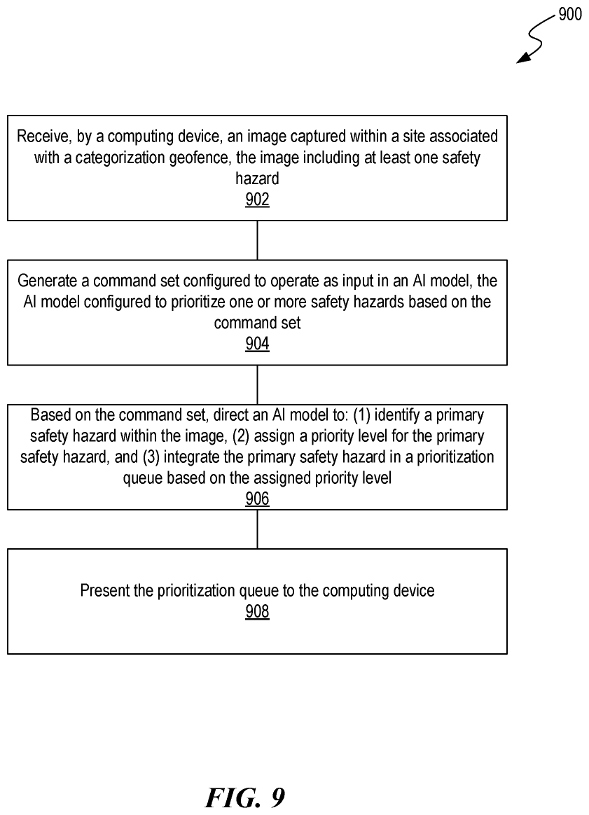

FIG. 9 is a flow diagram illustrating a method 900 for creating a priority queue, in accordance with one or more embodiments.

In step 902, the dynamic hazard prioritization system receives, by a computing device, an image captured within a site associated with a categorization geofence, where the image includes at least one safety hazard. The categorization geofence corresponds to a virtual perimeter or boundary defined using geographic coordinates. The location where the message was sent is defined by a second geofence, which corresponds to a second virtual perimeter or second boundary defined using geographic coordinates of the location, and has a smaller area than the categorization geofence.

In some embodiments, the dynamic hazard prioritization system also receives, by the computing device, a text input associated with the image. The text input includes additional context related to the primary safety hazard captured in the image. In some embodiments, the user input includes a set of tiers, where each tier is associated with a set of security hazards and directs the AI model to adjust the priority level of the primary safety hazard based on the associated tier of the primary safety hazard.

In step 904, the dynamic hazard prioritization system generates a command set that operates as input in an AI model that prioritizes one or more safety hazards based on the command set. The command set includes the image and an instructive parameter. The command set, in some embodiments, includes a predefined priority list of potential issues specific to the site. The instructive parameter is pre-loaded into the AI model and includes contextual information (e.g., data related to a specific location within the site where the query was sent, environmental parameters of the site, operational constraints, safety regulations, historical issue data, site-specific protocols) of the image specific to the categorization geofence.

Data related to the specific location within the site where the query was sent, or other location-specific data, includes details such as the geographical coordinates, spatial layout of the site, and proximity to important infrastructure or high-risk zones. By integrating location-specific data, the system accounts for site-specific characteristics and potential localized risks. For example, if the reported location is adjacent to a high-voltage electrical panel or a confined space with limited ventilation, the system assigns a higher priority to the reported hazard due to the increased potential for severe consequences in case of an incident. Conversely, if the reported location is in a low-traffic area with minimal equipment exposure, the system lowers the prioritization of the hazard due to the hazard's lower impact on overall safety operations.

Environmental parameters of the site, which include a wide range of factors such as ambient temperature, humidity levels, lighting conditions, and air quality, provide contextual cues that are able to influence the nature and severity of safety hazards. For example, a chemical spill in a confined space with poor ventilation poses greater risks compared to the same spill in an open-air environment.

Furthermore, operational constraints and safety regulations provide guidelines and compliance requirements that shape hazard prioritization strategies. Operational constraints include factors such as equipment availability, staffing levels, and workflow disruptions, which impact the feasibility and effectiveness of hazard mitigation measures. For example, in a manufacturing plant where certain machinery is crucial for safety measures, if the machinery undergoes maintenance or repair, the repair limits the plant's ability to address safety hazards effectively until the machinery is operational again. The hazard prioritization system takes the operational constraint into account and recognizes the implications of halting production and the potential economic losses, therefore recommending lowering the priority of the repairs until off-peak hours.

Similarly, safety regulations govern permissible actions and protocols for addressing safety hazards within the workplace to ensure adherence to industry standards and legal requirements. Safety regulations, such as those set by health and safety administrations, set rules for handling hazardous materials or ensuring worker safety in hazardous environments. Failure to comply with these regulations results in fines or legal consequences for the organization. For example, if a report is submitted regarding a spill of hazardous chemicals, the system automatically assigns a higher priority to address this issue with increased urgency, in accordance with hazardous material regulations.

Additionally, historical issue data and site-specific protocols draw upon past experiences and established best practices to inform hazard analysis and prioritization strategies. Historical issue data include data such as records of previous safety incidents, near misses, or corrective actions taken within the site, which provide context on recurring hazards and vulnerabilities. For example, if the facility has recorded multiple incidents of machinery malfunction resulting in worker injuries, the system recognizes the importance of addressing equipment malfunctions promptly to mitigate the risk of further injuries. Consequently, when a new report is submitted regarding a malfunctioning machine, the system automatically assigns a higher priority to address this issue due to the potential impact on worker safety and the historical precedence of similar incidents.

Site-specific protocols outline standardized procedures and protocols for addressing common safety hazards or emergency situations, which offers a structured framework for hazard prioritization and response. For example, a protocol is created for responding to chemical spills within the facility. The protocol includes steps such as immediate notification of the spill, evacuation procedures for nearby personnel, containment measures to prevent the spread of hazardous materials, and cleanup protocols to mitigate environmental impact. In the event of a chemical spill incident, the hazard prioritization system automatically triggers the corresponding site-specific protocol based on the reported hazard and prioritizes the incident in accordance with the protocol (e.g., placing the report higher on the prioritization queue if immediate action is required).

In some embodiments, the dynamic hazard prioritization system provides a user interface of the computing device to receive user input. The dynamic hazard prioritization system modifies the command set based on the user input. For example, the modification includes dynamically adjusting the parameters of the AI model, adding commands, or removing commands. The prioritization queue is modified, in some embodiments, based on the user input, where the modification includes editing issues, adding issues, or removing issues. Editing issues include updating existing issues within the prioritization queue. On the other hand, adding issues includes inserting new issues into the prioritization queue. Further, removing issues includes discarding issues from the prioritization queue.

In some embodiments, the command set is created by selecting one or more prompts from a set of predefined prompts. Each predefined prompt is specific to a corresponding site and modifies the instructive parameter of the command set. By selecting appropriate prompts based on the nature of the reported issue or the characteristics of the site, the system dynamically adjusts the instructive parameters of the command set to reflect the unique context of each safety incident. In some embodiments, the command set generation process incorporates adaptive prompting techniques, where the system selects prompts based on contextual cues derived from the reported safety hazard or user interactions. Through natural language processing (NLP) and machine learning algorithms (further discussed in FIG. 17), the system assesses the content of the reported issue, identifies key keywords or phrases indicative of specific types of safety hazards, and tailors the prompting sequence accordingly. By adapting the prompts dynamically in response to user input, the system ensures that the generated command set captures the most relevant information for prioritizing and addressing the reported safety concern.

The command set is generated consistently and impartially across different scenarios and users, which ensures uniformity and fairness in hazard prioritization. Unlike humans, who may be influenced by personal experiences, perceptions, or external factors, the system applies the same criteria and algorithms regardless of individual biases or emotions. For example, rather than prioritizing the hazard based on past experiences with the reporting individual, the vocalness or tone of the report, or personal perceptions of the severity of the reported hazard, the hazard is prioritized based on objective factors such as the proximity of the hazard to other personnel and relevant safety regulations. The system's impartiality helps mitigate potential conflicts of interest or favoritism that arise in manual hazard prioritization processes and decreases the risk of decisions being influenced by personal relationships, organizational politics, or other extraneous factors.

In some embodiments, the command set creation process analyzes the semantics and syntax of the reported safety hazard to identify relevant parameters or attributes that influence the hazard's severity, urgency, or impact on operations. The system generates instructive parameters that encode the extracted insights, enabling the AI model to prioritize safety hazards effectively based on the hazard's contextual significance.

In step 906, the dynamic hazard prioritization system directs an AI model to, based on the command set, identify a primary safety hazard within the image, assign a priority level for the primary safety hazard, and integrate the primary safety hazard in a prioritization queue based on the assigned priority level. Safety hazards with higher priority are placed earlier in the prioritization queue. In some embodiments, the priority of at least one issue is assigned based on the speed of resolution, type of issue, potential impact on the site, and/or proximity to sensitive areas or personnel within the site.

In some embodiments, the AI model is pre-loaded with site-specific escalation protocols. The command set causes the AI to automatically prioritize the primary safety hazard based on the site-specific escalation protocols. The protocols outline hierarchical guidelines for assessing the severity and urgency of different safety hazards commonly encountered within each specific environment. By pre-loading these escalation protocols into the AI model, the system ensures that the prioritization process aligns with the unique risk profiles and operational requirements of each site.

In some embodiments, the AI model dynamically adapts the model's prioritization criteria based on real-time contextual cues and historical data pertaining to the site. Through continuous learning and refinement, the system analyzes past incident patterns, environmental factors, and organizational priorities to fine-tune the system's prioritization algorithms and decision-making logic. The adaptive approach enables the AI model to respond flexibly to evolving safety conditions and emerging threats within the site.

In some embodiments, the AI model uses contextual information derived from site-specific or hazard-specific geofencing data to inform the AI model's prioritization decisions. By geofencing distinct areas within the site and associating them with different risk levels or hazard categories, the system uses spatial context as a determinant factor in prioritizing safety hazards. For example, hazards occurring in high-risk zones or critical operational areas receive higher priority compared to those occurring in low-risk or peripheral locations.

In some embodiments, the AI model is stored in a cloud environment hosted by a cloud provider, or a self-hosted environment. In a cloud environment, the AI model the scalability of cloud services provided by platforms (e.g., AWS, Azure). In some embodiments, storing the AI model in a cloud environment entails selecting the cloud service, provisioning resources dynamically through the provider's interface or APIs, and configuring networking components for secure communication. Cloud environments allow the AI model to handle varying levels of storage without the need for manual intervention. As the size of the dataset or the complexity of the model grows, significant computational power and storage capacity are needed. Cloud platforms provide scalable computing resources, allowing organizations to easily scale up or down based on computational demands. Additionally, storing the AI model in the cloud enables remote access from anywhere with an internet connection. The accessibility facilitates collaboration among team members located in different geographical locations and allows for integration with other cloud-based services and applications.

Conversely, in a self-hosted environment, the AI model is stored on a private server. In some embodiments, storing the AI model in a self-hosted environment entails setting up the server with the necessary hardware or virtual machines, installing an operating system, and storing the AI model. In a self-hosted environment, organizations have full control over the AI model, which allows organizations to implement customized security measures and compliance policies tailored to the organization's specific needs. For example, organizations in industries with strict data privacy and security regulations, such as finance institutions, are able to mitigate security risks by storing the AI model in a self-hosted environment.

In step 908, the dynamic hazard prioritization system presents the prioritization queue to the computing device, where the queue, in some embodiments, is accessed through a dedicated application or web interface.

In some embodiments, the dynamic hazard prioritization system integrates the prioritization queue with existing workflow management tools or safety management platforms used within the organization to ensure that safety managers and relevant stakeholders have easy access to prioritized safety hazards alongside other operational data and tasks.

In some embodiments, the dynamic hazard prioritization system notifies users about newly prioritized safety hazards or updates to the prioritization queue. Through push notifications, email alerts, or SMS messages, users are able to stay informed about safety issues and take timely actions to address the issues, even when the users are not actively monitoring the system's interface.

In some embodiments, the dynamic hazard prioritization system allows users to generate insights and reports based on the prioritization queue data. By offering customizable dashboards, data visualization tools, and export functionalities, the system allows users to analyze trends, track performance metrics, and make data-driven decisions to improve workplace safety and risk management strategies.

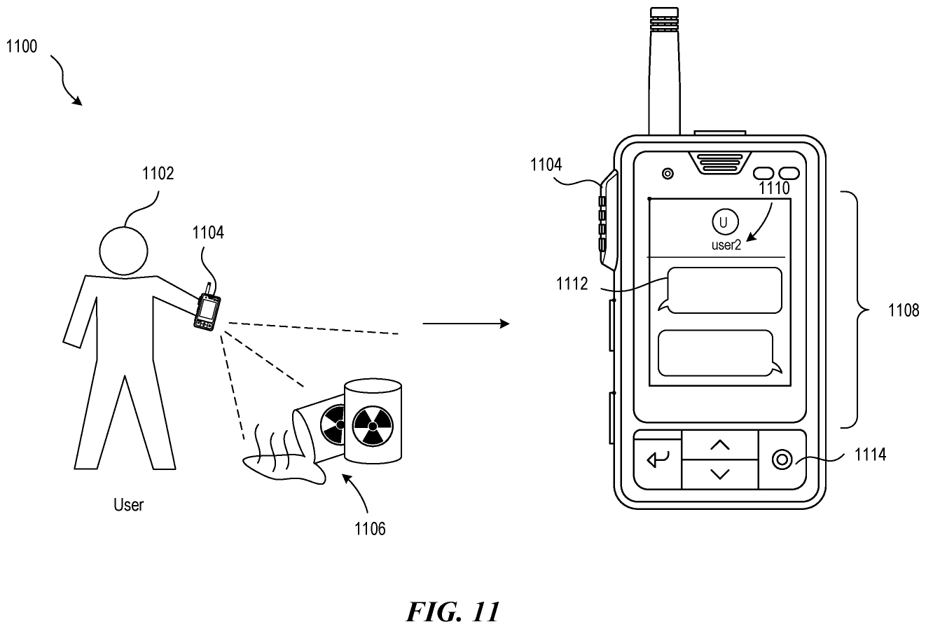

In some embodiments, in response to receiving the image, the dynamic hazard prioritization system establishes a communication channel between the first safety user device and the second safety user device. For more detail, see FIG. 11.

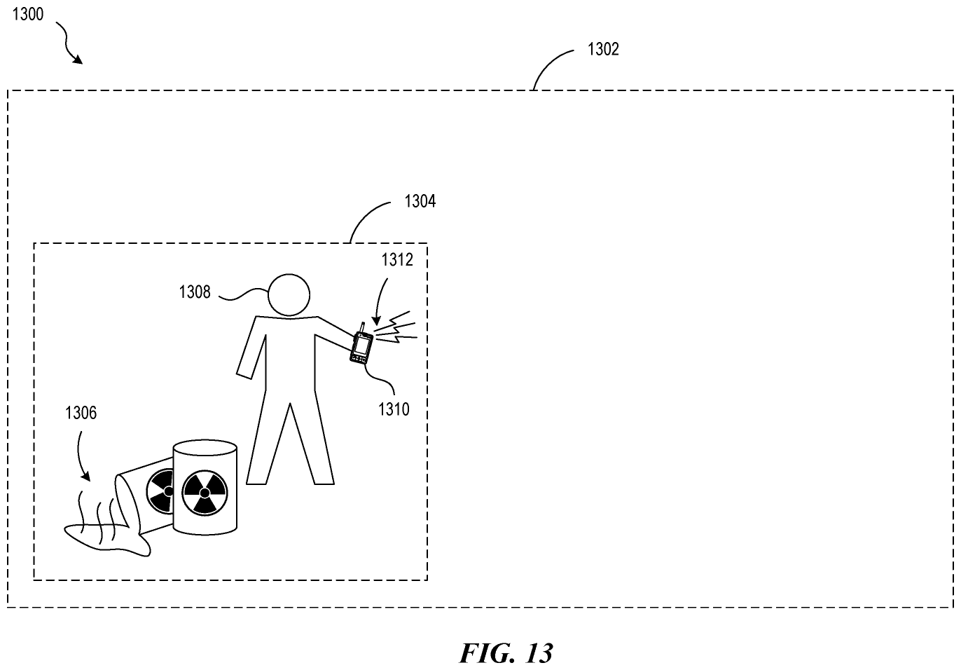

In some embodiments, the dynamic hazard prioritization system detects the presence of a second computing device within the geofence. In response to detecting the presence, the dynamic hazard prioritization system automatically transmits a notification through a speaker of the second computing device indicating the presence of the primary safety hazard. For more detail, see FIG. 13.

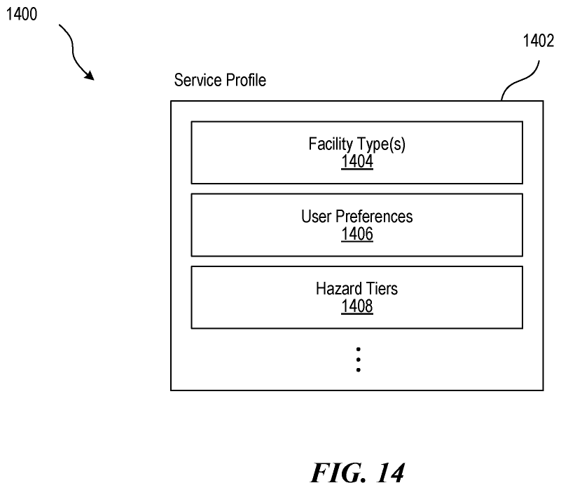

In some embodiments, the dynamic hazard prioritization system creates a service profile for the first computing device including the instructive parameter. The system modifies the service profile based on changes in the instructive parameter or the site. For more detail, see FIG. 14.

In some embodiments, the dynamic hazard prioritization system receives user feedback for the prioritization queue from the computing device. The user feedback relates to deviations between the assigned priority level and the desired priority level for the issue. In response to receiving user feedback, the dynamic hazard prioritization system iteratively adjusts the instructive parameter to better align the assigned priority level and the desired priority level for the issue.

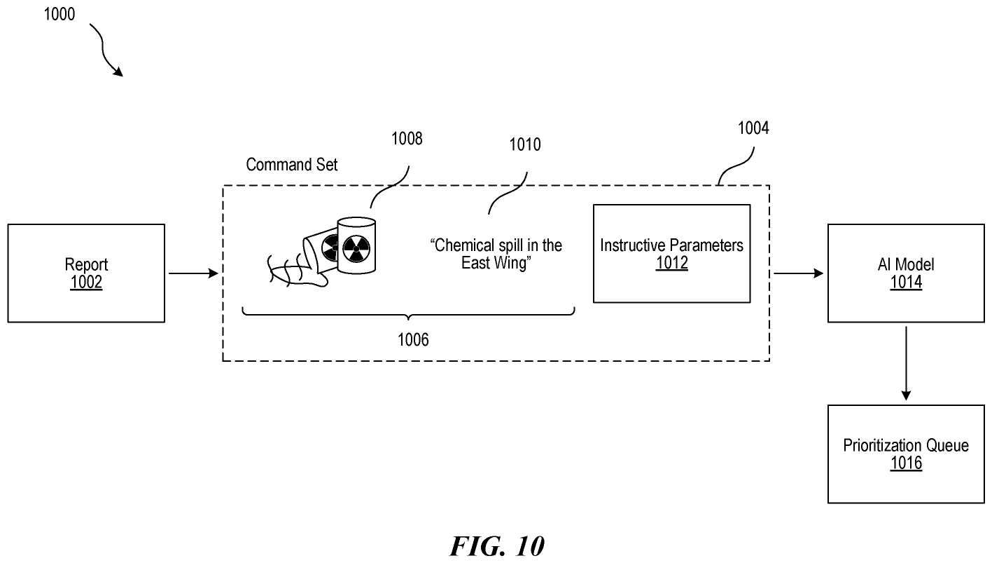

FIG. 10 is a block diagram 1000 illustrating creating a command set to operate as an input in an AI model, in accordance with one or more embodiments.

The report 1002 of a safety hazard, serves as the basis for constructing the command set 1004. The report 1002 includes user-generated media 1006 such as images 1008 and/or accompanying text 1010. In some embodiments, sensor data from loT devices deployed throughout the workplace environment could automatically trigger the creation of a command set 1004 upon detecting abnormal conditions or safety hazards. In some embodiments, the command set 1004 is generated based on real-time data feeds from external sources such as weather forecasts, equipment status monitors, or incident databases, to allow a system to proactively identify potential safety risks before the risks escalate. Additionally, in some embodiments, the command set 1004 incorporates inputs from predictive analytics models or risk assessment algorithms, which analyze historical data patterns and trend analyses to anticipate future safety hazards and prescribe preventive measures accordingly. The command set 1004 is dynamically adjusted or refined based on user feedback or corrective actions taken in response to previously reported safety hazards.

The dynamic hazard prioritization system extracts attributes and contextual information for prioritizing the safety hazard. The instructive parameters 1012, embedded within the command set 1004, provides insights into the nature and/or severity of the safety hazard, which allows the command set 1004 to be tailored to a user or an organization's specific needs. In some embodiments, the command set 1004 uses advanced natural language processing (NLP) techniques to extract relevant information from unstructured text data sources such as user generated media 1006, incident reports, safety manuals, and/or regulatory documents.

In some embodiments, the dynamic hazard prioritization system uses an AI model 1014 trained on historical safety incident data to automatically extract attributes and contextual information relevant to prioritizing safety hazards. By analyzing past incidents and their outcomes, the system identifies common patterns, trends, and risk factors associated with different types of safety hazards, allowing the system to prioritize current reports more effectively. Additionally, in certain implementations, the system integrates external databases or knowledge repositories containing industry-specific safety guidelines, best practices, and regulatory requirements. By cross-referencing the reported safety hazard against the contextual information, the system assigns appropriate priority levels for the command set.

In some embodiments, the command set generation process uses predefined decision rules or algorithms tailored to prioritize safety issues based on specific criteria. The decision rules encompass a range of factors, including the severity of the reported hazard, the hazard's potential impact on personnel or operations, the likelihood of occurrence, and any regulatory compliance considerations.

In some embodiments, the AI model 1014 uses machine learning techniques to autonomously learn and adapt the AI model's 1014 prioritization criteria based on historical data and user feedback. Through a process of continuous learning and refinement, the AI model analyzes patterns and trends in past safety incidents to identify relevant features and relationships associated with different levels of risk.

In some embodiments, the AI model 1014 uses multiple models with different architectures or training methodologies and combines the outputs to improve overall prediction performance. By aggregating the outputs of diverse models within the ensemble, the system mitigates the risk of overfitting specific datasets or biases inherent in individual algorithms, leading to more reliable prioritization outcomes. Additionally, ensemble learning improves the system's ability to generalize across different types of safety hazards.

The command set 1004, derived from the information in the report, operates as an input in the AI model 1014. The AI model 1014 evaluates the command set 1004 and assigns priority levels to each reported safety issue or just the primary safety hazard. Upon completion of the prioritization, the AI model 1014 generates a prioritization queue 1016, which is a dynamic list organized to highlight the severity and/or urgency of each reported safety hazard. The AI model 1014 is structured to provide an output in response to command sets (e.g., queries, prompts). For example, the dynamic hazard prioritization system is designed to use prompt engineering to transform the user's input image 1008 and/or supplemental text 1010 before inputting the command set into the AI model 1014.

Prompt engineering is a process of structuring text that is able to be interpreted by a generative AI model. For example, in some embodiments, a prompt (e.g., command set) includes the following elements: instruction, context, input data, and output specification. Although a prompt is a natural-language entity, a number of prompt engineering strategies help structure the prompt in a way that improves the quality of output. For example, in the prompt “Please generate an image of a bear on a bicycle for a children's book illustration,” “generate,” is the instruction, “for a children's book illustration” is the context, “bears on a bicycle” is the input data, and “an image” is the output specification. The techniques include being precise, specifying context, specifying output parameters, specifying target knowledge domain, and so forth.

Automatic prompt engineering techniques have the ability to, for example, include using a trained large language model (LLM) to generate a plurality of candidate prompts, automatically score the candidates, and select the top candidates. In some embodiments, prompt engineering includes the automation of a target process—for instance, a prompt causes a trained model to generate computer code, call functions in an API, and so forth. Additionally, in some embodiments, prompt engineering includes automation of the prompt engineering process itself—for example, an automatically generated sequence of cascading prompts, in some embodiments, include sequences of prompts that use tokens from trained model outputs as further instructions, context, inputs, or output specifications for downstream trained models. In some embodiments, prompt engineering includes training techniques for LLMs that generate prompts (e.g., chain-of-thought prompting) and improve cost control (e.g., dynamically setting stop sequences to manage the number of automatically generated candidate prompts, dynamically tuning parameters of prompt generation models or downstream models).

To identify the primary safety hazard in a report, in some embodiments, the AI model 1014 preprocesses the input image 1008 to enhance the image. Preprocessing techniques include, for example, resizing the image 1008, normalizing pixel values, and/or applying image augmentation methods to increase dataset variability. Then, in some embodiments, the AI model 1014 produces probability distributions over predefined classes of safety hazards. By comparing these probability scores, the AI model 1014 identifies the most likely primary safety hazard present in the image 1008.

To determine a priority level for each safety hazard, in some embodiments, AI model 1014 uses decision trees or classification algorithms. For example, decision trees recursively partition the feature space based on threshold values of input features, such as hazard severity and/or impact on operations. At each node of the tree, the algorithm selects the feature that best splits the data, resulting in a hierarchy of decision rules that classify safety hazards into different priority levels.

In some embodiments, the AI model 1014 predicts the priority level based on continuous variables such as the severity of the hazard, the estimated time to resolve the issue, and the potential impact on operations. Linear regression, for example, fits a linear relationship between the input features and the priority level, allowing for the estimation of priority levels based on the weighted sum of feature values.

In some embodiments, multiple models are trained independently, and the models' predictions are combined in an AI model 1014 to produce a final priority level assignment. For example, random forests or gradient boosting aggregates the predictions of multiple base models. In the case of random forests, multiple decision trees are trained independently, and the trees' predictions are aggregated to produce the final prediction. Each decision tree in the forest is trained on a random subset of the data and selects a random subset of features at each node, which helps to reduce overfitting and improve generalization. Similarly, gradient boosting combines the predictions of multiple weak learners, such as decision trees, sequentially. Each new model in the gradient boosting ensemble is trained to correct the errors made by the previous models, resulting in a stronger AI model 1014 that is able to generalize well to unseen data.

In some embodiments, the AI model 1014 dynamically adjusts priority levels based on feedback received during the system's operation. The AI model interacts with the environment (i.e., the hazard prioritization management system) and continuously refining the priority assignment strategies over time. For example, the model adjusts the model's parameters to minimize safety incidents or response times based on feedback that a certain area of the site has experienced longer than normal wait times.

In some embodiments, fuzzy logic-based approaches are used to handle uncertainty and imprecision in priority level assignments. The AI model incorporates linguistic variables and fuzzy membership functions to allow for nuanced and flexible priority assessments. By defining fuzzy rules that capture the relationship between input variables and priority levels, the AI model makes decisions based on degrees of truth rather than binary classifications.

In some embodiments, the original report 1002 is fully integrated into the prioritization queue 1016 to ensure that safety personnel have access to comprehensive information as the safety personnel navigate through the prioritization queue 1016.

FIG. 11 is a block diagram 1100 illustrating initiating a communication channel between two safety user devices in response to reporting an issue, in accordance with one or more embodiments.

The user 1102, uses the safety user device 1104 to capture images of a safety hazard 1106 encountered in the site (e.g., workplace). Once the safety hazard 1106 is reported, the system creates a communication channel 1108 between the reporting user 1102 and the receiving user 1110 operating the receiving device. The communication channel 1108 serves as a link for exchanging information and facilitating a more efficient resolution of the reported issue. The communication channel 1108, in some embodiments, is established through various communication mediums such as instant messaging platforms, email, or dedicated communication applications integrated with the dynamic hazard prioritization system (e.g., a voice to text message thread that is played both audibly and presented in text such as that associated with smart radio described herein).

In some embodiments, the dynamic hazard prioritization system offers integrated communication features within the system's user interface, allowing users to initiate communication channels 1108 directly from the system's dashboard or incident management interface. By incorporating real-time chat functionality and/or video conferencing capabilities, the system allows receiving users to engage in collaborative discussions, share multimedia files, and escalate urgent issues.

Within the communication channel 1108, in some embodiments, messaging capabilities 1112 are available to user 1102, allowing user 1102 to communicate regarding the reported safety hazard 1106. The messaging capabilities 1112 include features such as instant messaging (e.g., through voice to text messaging), threaded conversations, and/or status updates, allowing for efficient communication exchanges that enhance incident resolution efforts and streamline coordination between the reporting individual and the safety personnel.

In some embodiments, voice to text messaging capabilities through a Push-to-Talk (PTT) key 1114 are incorporated into the communication channel that allows users to interact more easily through the interface. When communicating through the communication channel, the user can press the PTT key to initiate voice communication. The action triggers the device to capture the user's message. Once the user presses the PTT key, the device begins recording the audio input from the user's voice. The voice communication is then transmitted wirelessly to a central server or cloud-based platform where the audio data is processed. The server or platform uses speech-to-text transcription to convert the spoken audio into text format by analyzing the audio waveform to identify speech patterns and recognize individual words and phrases. After transcribing the audio into text, the hazard description is delivered to the device of the receiving user 1110. A voice-based interaction modality improves accessibility and user convenience, particularly in situations where manual input or touch-screen interactions are impractical or cumbersome (e.g., when wearing bulky protective gear such as gloves).

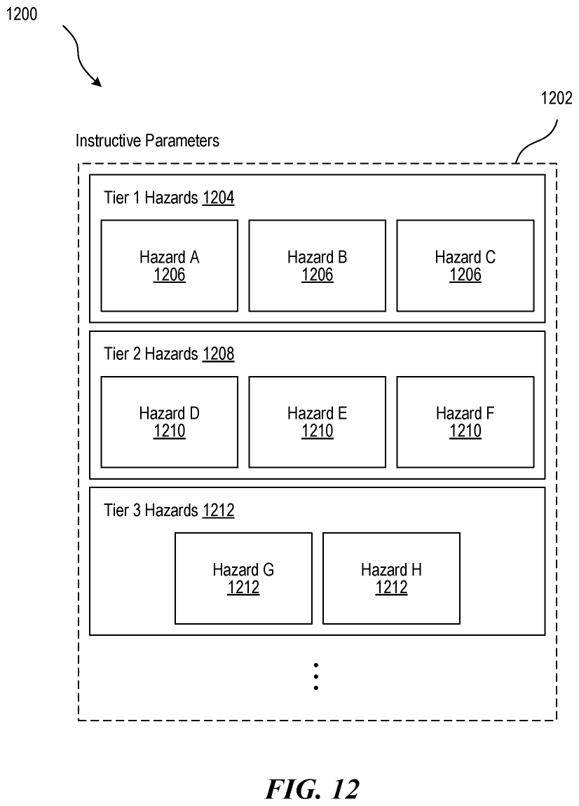

FIG. 12 is a block diagram 1200 illustrating a tiered system of safety hazards, in accordance with one or more embodiments.

Within instructive parameters 1202, there is a tiered system of groups of safety hazards. Tiers within the system are ranked by priority, with the first tier being the highest priority and subsequent tiers representing progressively lower levels of urgency.

In some embodiments, the tiered system of safety hazards is organized based on the potential impact or consequences associated with each hazard. Hazards with the highest potential impact or severity are assigned to the first tier, while hazards with lesser consequences are allocated to lower tiers. Organizing hazards based on potential impact ensures that resources and attention are directed toward mitigating the most critical risks first, thereby minimizing potential harm or damage within the workplace environment. For example, the first tier includes the highest-priority hazards that require immediate attention and resolution (e.g., a chemical spill). Subsequent tiers within the system include progressively lower levels of urgency, indicating hazards that will be addressed with less immediacy or severity (e.g., a damaged handrail).

In some embodiments, the tiered system of safety hazards incorporates feedback mechanisms and/or periodic reviews to reassess the priority levels assigned to each tier. For example, regular evaluations of workplace conditions, incident reports, and risk assessments inform adjustments to the tier structure. For example, if incident reports indicate a spike in falls from elevated heights due to ongoing roofing work, the tier associated with fall hazards is elevated to reflect the heightened risk level. The iterative approach allows the tiered system to adapt dynamically to emerging threats and prioritize resources effectively to address current safety challenges.

In some embodiments, each tier has a separate protocol or set of guidelines for addressing and managing the safety hazards within it, to ensure a systematic and structured approach to safety hazard prioritization throughout the organization.

For example, tier 1 hazards 1204 consists of specific safety hazards such as hazards A-C 1206, each representing a distinct safety issue that poses significant risks to workplace safety. Tier 1 hazards 1204, in some embodiments, has protocols that mandate immediate action and escalation procedures for critical safety issues such as chemical spills or structural collapses. Safety protocols for Tier 1 hazards include protocols such as emergency response, evacuation procedures, and communication protocols to alert relevant stakeholders.

On the other hand, tier 2 hazards 1208 encompass safety hazards of moderate severity that do not require immediate attention but still necessitate prompt action. Within Tier 2, hazards D-F 1210 are identified, representing a range of safety concerns that warrant careful consideration and proactive management, but are not as urgent as hazards in the tier 1 hazards 1204. Tier 2 hazards 1208, in some embodiments, has protocols that prioritize timely mitigation efforts and proactive measures to prevent escalation. Protocols for Tier 2 hazards involve protocols such as regular inspections, maintenance routines, and training programs to address common safety risks such as slip and fall hazards or equipment malfunctions.

Tier 3 hazards 1212 includes safety hazards of relatively lower priority or severity compared to tier 1 hazards 1204 and tier 2 hazards 1208. Hazards G and H within tier 3 represent safety concerns that will be addressed in due course but do not pose immediate threats to workplace safety. Tier 3 hazards 1212, in some embodiments, has protocols focused on long-term risk management and continuous improvement initiatives. Tier 3 hazards 1212 include protocols such as safety audits, hazard identification programs, and feedback mechanisms to identify emerging safety trends and areas for improvement.

Users are able to dictate, in some embodiments, which types of hazards belong to each tier. In some embodiments, user preferences 1406 are customizable through a dedicated user interface or settings dashboard that allows users to configure the user's notification preferences and risk tolerance levels. For example, the GUI provides administrators with controls to categorize hazards, define tier thresholds, and establish tier-specific criteria for prioritization. Through the GUI, administrators can easily view, modify, and manage the tier assignments for various safety hazards within the system. Once the hazard tiers are defined and configured within the GUI, the selected tier assignments are employed by the instructive parameters within the hazard prioritization system. In some embodiments, when administrators update tier assignments or modify tier thresholds, the instructive parameters are automatically updated to reflect the changes. Within the instructive parameters, each hazard category is associated with metadata that includes the category's assigned tier, priority criteria, and any additional attributes relevant to prioritization. The metadata serves as the basis for the system's decision-making process when integrating the safety hazard into the prioritization queue.

FIG. 13 is a block diagram 1300 illustrating notifying other users within the surrounding area of a safety hazard, in accordance with one or more embodiments.

The site geofence 1302 serves as a boundary defining the geographic area of the workplace or site where safety hazards are potentially present. Within the site geofence, the hazard geofence 1304 defines the vicinity of the identified safety hazard 1306, forming a virtual perimeter around the hazard to denote the hazard's 1306 spatial extent. In some embodiments, the hazard geofence 1304 is dynamically generated based on the coordinates of the reported safety hazard.

In some embodiments, the site geofence includes multiple designated zones or areas within the workplace, each representing different operational regions where safety hazards potentially arise. The zones are predefined based on factors such as workflow processes, equipment usage areas, and/or environmental conditions, allowing for targeted hazard management strategies within each zone.

In some embodiments, the hazard geofence incorporates dynamic resizing capabilities to adapt to changes in the spatial extent of the safety hazard over time. For example, if the hazard spreads or migrates within the workplace, the hazard geofence automatically adjusts the boundaries (e.g., based on future reports of the same hazard) to reflect the updated extent of the hazard to ensure continued accuracy in hazard localization and monitoring. In some embodiments, the hazard geofence is dynamically generated based on the tier of the hazard. For example, if a chemical spill is categorized as a high-tier hazard due to the spill's potential to cause severe harm to personnel or the environment, the hazard geofence generated around the spill encompasses a larger area compared to a lower-tier hazard. The hazard geofence for the high-tier chemical spill extends beyond the immediate vicinity of the spill itself to cover nearby work areas, access routes, and emergency exits to ensure that all personnel within the facility are promptly alerted to the presence of the hazardous substance, even if the personnel are not in direct proximity to the spill.

When another user 1308 equipped with a safety user device 1310 enters the hazard geofence 1304 while within the broader site geofence 1302, the safety user device 1310 detects the user's presence within the proximity of the safety hazard 1306. The detection can be achieved through various means, such as GPS positioning, Bluetooth Low Energy (BLE) beacon technology (discussed further in FIG. 1), and/or RFID tags installed within the hazard geofence area. For example, beacon devices placed throughout the site emit signals that are detected by users' mobile devices or wearable sensors, indicating the user's proximity to specific safety hazards. Upon detecting these beacon signals, the system triggers immediate notifications to notify users of the nearby safety hazard 1306.

In response to the detection, the safety user device 1310 alerts the user 1308 through a notification 1312 of the potential safety hazard in the user's 1308 vicinity. The notification 1312 generated by the safety user device 1310 serves as a real-time alert to inform the user 1308 about the presence of the safety hazard 1306 nearby, enabling the user 1308 to exercise caution and take appropriate actions to mitigate any potential risks. In some embodiments, notification 1312 is delivered via audible alarms, visual indicators, and/or vibration alerts on the safety user device 1310. In some embodiments, the notification 1312 includes relevant information about the nature of the safety hazard 1306 and recommended actions for the user 1308 to take to ensure the user's 1308 safety. In some embodiments, the safety user device 1310 provides customizable alert settings, allowing user 1308 to configure the user's 1308 preferences for receiving hazard notifications based on factors such as proximity thresholds, notification frequency, and/or alert tones. In some embodiments, the system adjusts the characteristics of the hazard geofence accordingly based on the hazard's tier by implementing varying levels of alert mechanisms. For example, low-tier hazards do not necessitate immediate audible warnings, since the hazard poses a lower risk to personnel or operations compared to higher-tier hazards. Rather, for low-tier hazards, the hazard geofence triggers visual or text-based notifications on safety user devices within the vicinity to alert users to the presence of the hazard without causing undue alarm. The notifications provide relevant information about the hazard and recommended precautions, which allows users to proceed with caution while minimizing disruption to normal operations.

By using geofencing technology to automatically trigger notifications based on user proximity to safety hazards, the dynamic hazard prioritization system improves safety awareness and reduces risk among users within the environment.

FIG. 14 is a block diagram 1400 illustrating a service profile, in accordance with one or more embodiments.

The service profile 1402 is integrated into the command set inputted into the AI model (e.g., as instructive parameters). The integration process, in some embodiments, involves extracting relevant information from the service profile, such as facility types, user preferences, and/or hazard tiers, and encoding the relevant information into a structured format suitable for input into the AI model. In some embodiments, the service profile 1402 is preprocessed to transform any raw data into a format compatible with the AI model's input requirements. For example, preprocessing includes data normalization, feature engineering, and/or data encoding techniques to ensure that the information contained within the service profile is accurately represented in the command set. Once the service profile 1402 is prepared, the parameters are appended to the command set.

Facility types 1404, in some embodiments, which categorizes the different types of workplaces or sites where the dynamic hazard prioritization system is deployed, are included in the service profile. The facility types define the operational context and risk landscape within which safety hazards are identified and managed. By incorporating facility types into the service profile, the system tailors the prioritization algorithms and response protocols to suit the unique characteristics and safety requirements of each specific workplace setting. In some embodiments, the service profile 1402 includes dynamic facility-type assignment mechanisms that automatically classify workplaces based on real-time data inputs or environmental factors. For example, sensor data from loT devices or geographic information system (GIS) data are used to dynamically identify and categorize facility types based on the current occupancy, activities, or environmental conditions within a given site. The dynamic approach ensures that the dynamic hazard prioritization system remains responsive to changing operational contexts.

Hazard tiers 1408, described in further detail in FIG. 12, categorize safety hazards into distinct levels of priority, enabling the system to differentiate between high-risk and low-risk hazards and allocate resources and attention accordingly. By incorporating hazard tiers into the service profile, organizations establish hierarchical frameworks for prioritizing safety hazard responses. In some embodiments, hazard tiers 1408 are dynamically generated and adjusted based on real-time data inputs and contextual factors such as current operational conditions and/or environmental variables. For example, by monitoring safety incident data, near-misses, and/or other relevant metrics, the system automatically recalibrates the hazard tiers to reflect changing risk profiles and evolving safety priorities.

In some embodiments, user preferences 1406 are derived from historical user interactions and feedback data collected over time. For example, the system analyzes past user behavior, response patterns, and/or engagement metrics to infer users' implicit preferences and adapt the communication strategies accordingly. In some embodiments, the system continuously refines communication methods to better meet the needs and expectations of individual users and organizations. In some embodiments, user preferences 1406 are customizable through a dedicated user interface or settings dashboard that allows users to configure the user's notification preferences and risk tolerance levels. In some embodiments, user preferences 1406 are synchronized across multiple devices and platforms through cloud-based storage methods. By maintaining a centralized repository of user preferences accessible from any authorized device or application, the system ensures consistency in the delivery of safety alerts and notifications across different safety user devices.

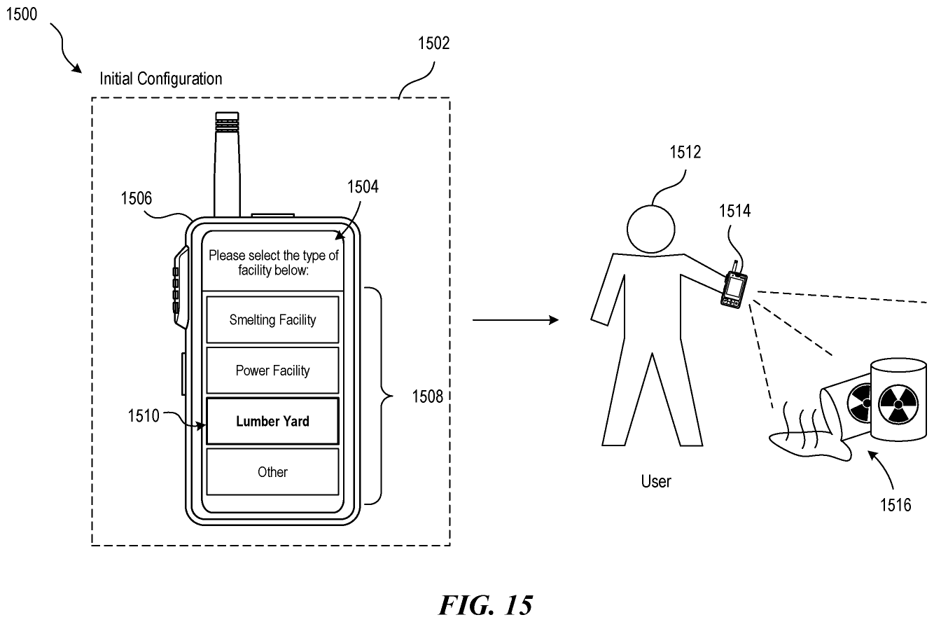

FIG. 15 is a block diagram 1500 illustrating using predefined prompts to create the command set, in accordance with one or more embodiments.

The facility type parameter within the automated hazard prioritization system is able to be set up during the initial configuration phase 1502. Administrators or system operators input information about the organization's various facility types, such as manufacturing plants, warehouses, office buildings, or construction sites. Each facility type encompasses distinct characteristics, operational workflows, and/or associated safety hazards. For example, a manufacturing plant is associated with hazards related to heavy machinery, chemical spills, or electrical hazards, while an office building faces risks such as slips, trips, falls, or ergonomic issues. For example, a prompt 1504 (e.g., “Please select the type of facility below”), is displayed on a GUI of the device 1506 during the initial configuration phase 1502, and offers predefined responses 1508 (e.g., smelting facility, power facility, lumber yard, other types) to enable the user to specify the context and/or nature of the facility type. The administrator interact with the prompt 1504 to make a selection and choose the most appropriate facility type. In some embodiments, a visual indicator 1510 appears on the chosen option.

In some embodiments, the system uses machine learning algorithms or predictive analytics to anticipate and select facility types based on contextual cues, historical data, and user behavior patterns. By analyzing past reporting trends, user preferences, and environmental factors, the system infers the facility type. For example, if most reported hazards occur near assembly lines or near specific machinery types, the system infers that the area is associated with manufacturing operations. The system then infers the facility type, such as “assembly line area” or “machine shop,” based on the contextual analysis.

The user 1512, uses the safety user device 1514 to capture images of a safety hazard 1516 encountered in the site (e.g., workplace). Once the image and/or text is reported, the device transmits the data to the hazard prioritization system, which automatically integrates the hazard into the prioritization queue. Since the facility type is already pre-configured, the system uses the pre-configured facility type and other contextual information provided by the geofence, such as the site location and associated hazard protocols, to automatically generate a command set tailored to the specific location and nature of the reported hazard.

### Computing Platform

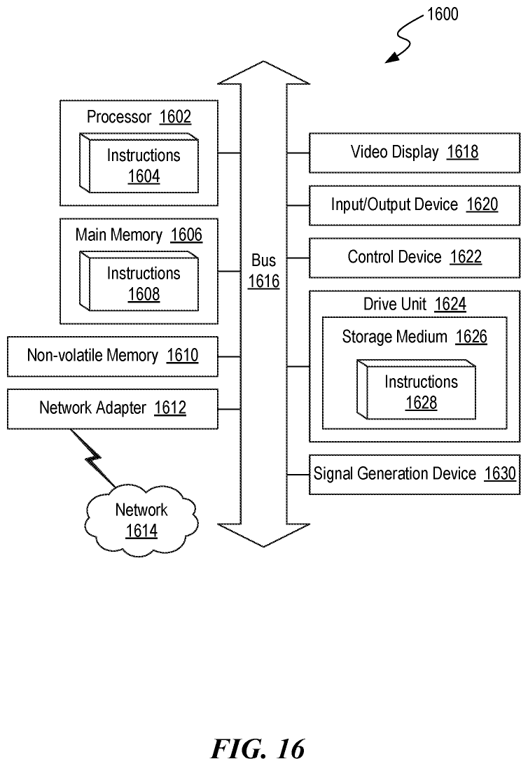

FIG. 16 is a block diagram illustrating an example computer system 1600, in accordance with one or more embodiments. In some embodiments, components of the example computer system 1600 are used to implement the software platforms described herein. At least some operations described herein can be implemented on the computer system 1600.

In some embodiments, the computer system 1600 includes one or more central processing units (“processors”) 1602, main memory 1606, non-volatile memory 1610, network adapters 1612 (e.g., network interface), video displays 1618, input/output devices 1620, control devices 1622 (e.g., keyboard and pointing devices), drive units 1624 including a storage medium 1626, and a signal generation device 1620 that are communicatively connected to a bus 1616. The bus 1616 is illustrated as an abstraction that represents one or more physical buses and/or point-to-point connections that are connected by appropriate bridges, adapters, or controllers. The bus 1616, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1694 bus (also referred to as “Firewire”).

In some embodiments, the computer system 1600 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1600.

While the main memory 1606, non-volatile memory 1610, and storage medium 1626 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1628. The term “machine-readable medium” and “storage medium” shall also be taken to include any medium that is capable of storing, encoding, or carrying a set of instructions for execution by the computer system 1600. In some embodiments, the non-volatile memory 1610 or the storage medium 1626 is a non-transitory, computer-readable storage medium storing computer instructions, which is executable by one or more “processors” 1602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1604, 1608, 1628) set at various times in various memory and storage devices in a computer device. When read and executed by one or more processors 1602, the instruction(s) cause the computer system 1600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1610, floppy and other removable disks, hard disk drives, optical discs (e.g., compact disc read-only memory (CD-ROMS), digital versatile discs (DVDs)), and transmission-type media such as digital and analog communication links.

The network adapter 1612 enables the computer system 1600 to mediate data in a network 1614 with an entity that is external to the computer system 1600 through any communication protocol supported by the computer system 1600 and the external entity. The network adapter 1612 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1612 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1700 illustrated and described in more detail with reference to FIG. 17.

### AI System

FIG. 17 is a high-level block diagram illustrating an example AI system, in accordance with one or more embodiments. The AI system 1700 is implemented using components of the example computer system 1700 illustrated and described in more detail with reference to FIG. 16. Likewise, embodiments of the AI system 1700 include different and/or additional components or be connected in different ways.

In some embodiments, as shown in FIG. 17, the AI system 1700 includes a set of layers, which conceptually organize elements within an example network topology for the AI system's architecture to implement a particular AI model 1730. Generally, an AI model 1730 is a computer-executable program implemented by the AI system 1700 that analyses data to make predictions. Information passes through each layer of the AI system 1700 to generate outputs for the AI model 1730. The layers include a data layer 1702, a structure layer 1704, a model layer 1706, and an application layer 1708. The algorithm 1716 of the structure layer 1704 and the model structure 1720 and model parameters 1722 of the model layer 1706 together form the example AI model 1730. The optimizer 1726, loss function engine 1724, and regularization engine 1728 work to refine and optimize the AI model 1730, and the data layer 1702 provides resources and support for the application of the AI model 1730 by the application layer 1708.

The data layer 1702 acts as the foundation of the AI system 1700 by preparing data for the AI model 1730. As shown, in some embodiments, the data layer 1702 includes two sub-layers: a hardware platform 1710 and one or more software libraries 1712. The hardware platform 1710 is designed to perform operations for the AI model 1730 and includes computing resources for storage, memory, logic, and networking, such as the resources described in relation to FIG. 4A. The hardware platform 1710 processes amounts of data using one or more servers. The servers can perform backend operations such as matrix calculations, parallel calculations, machine learning (ML) training, and the like. Examples of servers used by the hardware platform 1710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1710 includes Infrastructure as a Service (IaaS) resources, which are computing resources, (e.g., servers, memory, etc.) offered by a cloud services provider. In some embodiments, the hardware platform 1710 includes computer memory for storing data about the AI model 1730, application of the AI model 1730, and training data for the AI model 1730. In some embodiments, the computer memory is a form of random-access memory (RAM), such as dynamic RAM, static RAM, and non-volatile RAM.

In some embodiments, the software libraries 1712 are thought of as suites of data and programming code, including executables, used to control the computing resources of the hardware platform 1710. In some embodiments, the programming code includes low-level primitives (e.g., fundamental language elements) that form the foundation of one or more low-level programming languages, such that servers of the hardware platform 1710 can use the low-level primitives to carry out specific operations. The low-level programming languages do not require much, if any, abstraction from a computing resource's instruction set architecture, allowing them to run quickly with a small memory footprint. Examples of software libraries 1712 that can be included in the AI system 1700 include Intel Math Kernel Library, Nvidia cuDNN, Eigen, and Open BLAS.

In some embodiments, the structure layer 1704 includes an ML framework 1714 and an algorithm 1716. The ML framework 1714 can be thought of as an interface, library, or tool that allows users to build and deploy the AI model 1780. In some embodiments, the ML framework 1714 includes an open-source library, an application programming interface (API), a gradient-boosting library, an ensemble method, and/or a deep learning toolkit that works with the layers of the AI system facilitate development of the AI model 1730. For example, the ML framework 1714 distributes processes for the application or training of the AI model 1730 across multiple resources in the hardware platform 1710. In some embodiments, the ML framework 1714 also includes a set of pre-built components that have the functionality to implement and train the AI model 1730 and allow users to use pre-built functions and classes to construct and train the AI model 1730. Thus, the ML framework 1714 can be used to facilitate data engineering, development, hyperparameter tuning, testing, and training for the AI model 1730. Examples of ML frameworks 1714 that can be used in the AI system 1700 include TensorFlow, PyTorch, Scikit-Learn, Keras, Caffe, LightGBM, Random Forest, and Amazon Web Services.

In some embodiments, the algorithm 1716 is an organized set of computer-executable operations used to generate output data from a set of input data and can be described using pseudocode. In some embodiments, the algorithm 1716 includes complex code that allows the computing resources to learn from new input data and create new/modified outputs based on what was learned. In some implementations, the algorithm 1716 builds the AI model 1730 through being trained while running computing resources of the hardware platform 1710. The training allows the algorithm 1716 to make predictions or decisions without being explicitly programmed to do so. Once trained, the algorithm 1716 runs at the computing resources as part of the AI model 1730 to make predictions or decisions, improve computing resource performance, or perform tasks. The algorithm 1716 is trained using supervised learning, unsupervised learning, semi-supervised learning, and/or reinforcement learning.

The application layer 1708 describes how the AI system 1700 is used to solve problems or perform tasks. In an example implementation, the safety user device uses the application layer to receive communications such as the priority queue and/or the user input.

As an example, to train an AI model 1730 that is intended to model human language (also referred to as a language model), the data layer 1702 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1702 is annotated with ground truth labels (e.g., each data entry in the training dataset is paired with a label), or unlabeled.

Training an AI model 1730 generally involves inputting into an AI model 1730 (e.g., an untrained ML model) data layer 1702 to be processed by the AI model 1730, processing the data layer 1702 using the AI model 1730, collecting the output generated by the AI model 1730 (e.g., based on the inputted training data), and comparing the output to a desired set of target values. If the data layer 1702 is labeled, the desired target values, in some embodiments, are, e.g., the ground truth labels of the data layer 1702. If the data layer 1702 is unlabeled, the desired target value is, in some embodiments, a reconstructed (or otherwise processed) version of the corresponding AI model 1730 input (e.g., in the case of an autoencoder), or is a measure of some target observable effect on the environment (e.g., in the case of a reinforcement learning agent). The parameters of the AI model 1730 are updated based on a difference between the generated output value and the desired target value. For example, if the value outputted by the AI model 1730 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1730 typically is to minimize a loss function or maximize a reward function.

In some embodiments, the data layer 1702 is a subset of a larger data set. For example, a data set is split into three mutually exclusive subsets: a training set, a validation (or cross-validation) set, and a testing set. The three subsets of data, in some embodiments, are used sequentially during AI model 1730 training. For example, the training set is first used to train one or more ML models, each AI model 1730, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1730. Backpropagation is used to adjust (also referred to as update) the value of the parameters in the AI model 1730, with the goal of optimizing the objective function. For example, a defined loss function is calculated by forward propagation of an input to obtain an output of the AI model 1730 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1730 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1730 is sufficiently converged with the desired target value), after which the AI model 1730 is considered to be sufficiently trained. The values of the learned parameters are then fixed and the AI model 1730 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1730 typically involves further training the ML model on a number of data samples (which may be smaller in number/cardinality than those used to train the model initially) that closely target the specific task. For example, an AI model 1730 for generating natural language that has been trained generically on publicly available text corpora is, e.g., fine-tuned by further training using specific training samples. In some embodiments, the specific training samples are used to generate language in a certain style or a certain format. For example, the AI model 1730 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

I/We claim:

1. A method comprising:
receiving, by a computing device, an image captured within a site associated with a categorization geofence, the image including at least one safety hazard,
wherein the categorization geofence corresponds to a virtual perimeter or boundary defined using geographic coordinates;
generating a command set configured to operate as input in an artificial intelligence (AI) model, the AI model configured to prioritize one or more safety hazards based on the command set,
wherein the command set includes the image and an instructive parameter,
wherein the instructive parameter is pre-loaded into the AI model and includes contextual information of the image specific to the categorization geofence;
based on the command set, directing an AI model to:
identify a primary safety hazard within the image,
assign a priority level for the primary safety hazard, and
integrate the primary safety hazard in a prioritization queue based on the assigned priority level, wherein safety hazards with higher priority are placed earlier in the prioritization queue; and
presenting the prioritization queue to the computing device.

2. The method of claim 1, further comprising:
providing a user interface of the computing device, wherein the user interface is configured to receive a user input; and
modifying the command set based on the user input, wherein the modification includes one or more of: adjusting parameters of the AI model, adding commands, or removing commands.

3. The method of claim 1, wherein the image is transmitted to the computing device by a first safety user device, further comprising:
in response to receiving the image, establishing a communication channel between the first safety user device and a second safety user device.

4. The method of claim 1, further comprising:
receiving, by the computing device, a text input associated with the image,
wherein the text input includes additional context related to the primary safety hazard captured in the image,
wherein the text input is configured to operate as input in the AI model.

5. The method of claim 1, further comprising:
providing a user interface of the computing device, wherein the user interface is configured to receive a user input;
receiving a user input including a set of tiers, wherein each tier is associated with a set of security hazards; and
directing the AI model to adjust the priority level of the primary safety hazard based on the associated tier of the primary safety hazard.

6. The method of claim 5, wherein the computing device is a first computing device, further comprising:
detecting a presence of a second computing device within the geofence; and
in response to detecting the presence, automatically transmitting a notification through a speaker of the second computing device indicating the presence of the primary safety hazard.

7. The method of claim 1,
wherein the AI model is pre-loaded with site-specific escalation protocols,
wherein the command set causes the AI to automatically prioritize the primary safety hazard based on the site-specific escalation protocols.

8. A method comprising:
receiving, by a first computing device, a message indicating at least one issue related to a site associated with a categorization geofence, the message sent by a second computing device within the site,
wherein the categorization geofence corresponds to a virtual perimeter or boundary defined using geographic coordinates;
generating a command set configured to operate as input in an artificial intelligence (AI) model based on the categorization geofence and the message,
wherein the AI model is configured to prioritize the at least one issue indicated in the message based on the command set,
wherein the command set includes the message and an instructive parameter,
wherein the instructive parameter is pre-loaded into the AI model and includes contextual information of the message specific to the categorization geofence;
receiving a prioritization queue from the AI model including the at least one issue indicated in the message, wherein issues with higher priority are placed earlier in the prioritization queue; and
presenting the prioritization queue to the computing device.

9. The method of claim 8, further comprising:
providing a user interface of the computing device, wherein the user interface is configured to receive a user input; and
modifying the prioritization queue based on the user input, wherein the modification includes one or more of: editing issues, adding issues, or removing issues,
wherein editing issues includes updating existing issues within the prioritization queue,
wherein adding issues includes inserting new issues to the prioritization queue,
wherein removing issues includes discarding issues from the prioritization queue.

10. The method of claim 8, wherein the command set includes a priority list of potential issues specific to the site.

11. The method of claim 8, further comprising:
creating a service profile for the first computing device including the instructive parameter; and
modifying the service profile based on changes in one or more of: the instructive parameter or the site.

12. The method of claim 8, wherein generating the command set further comprises:
selecting one or more prompts from a set of predefined prompts,
wherein each predefined prompts are specific to a corresponding site,
wherein each predefined prompt modifies the instructive parameter of the command set.

13. The method of claim 8, wherein the categorization geofence is a first geofence, further comprising:
defining a location where the message was sent by a second geofence, wherein the second geofence corresponds to a second virtual perimeter or second boundary defined using geographic coordinates of the location,
wherein the second geofence has a smaller area than the first geofence.

14. The method of claim 8, wherein the priority of the at least one issue is assigned based on one or more of: speed of resolution, type of issue, potential impact to the site, and proximity to sensitive areas or personnel within the site.

15. A system comprising:
a communication interface of a first computing device configured to receive a query sent by a second computing device within a site, the query including an issue related to the site;
a prompt engineering module communicatively connected to an artificial intelligence (AI) model,
wherein the prompt engineering module is configured to generate a command set comprising: 1) the query and 2) an instructive parameter containing contextual information of the query specific to the site;
wherein the prompt engineering module is configured to direct the AI model to prioritize one or more issues based on the command set by:
identifying the issue within the query,
assigning a priority level for the issue, wherein the instructive parameter directs the AI model to assign the priority level based on the contextual information, and
placing the issue in a prioritization queue based on the assigned priority level, wherein issues with higher priority are placed earlier in the prioritization queue; and
a display screen of the first computing device configured to present the prioritization queue to the first computing device.

16. The system of claim 15, wherein the prompt engineering module, in response to detecting a change in one or more of: the query or the priority levels of issues within the site, cause the AI model to dynamically update the prioritization queue of the issues based on the detected changes.

17. The system of claim 15, wherein the contextual information included in the instructive parameter includes data related to a specific location within the site where the query was sent.

18. The system of claim 15, further comprising:
a feedback module configured to receive user feedback for the prioritization queue from the computing device,
wherein the user feedback relates to deviations between the assigned priority level and desired priority level for the issue;
wherein the feedback module is further configured to, in response to receiving the user feedback, iteratively adjust the instructive parameter to better align the assigned priority level and the desired priority level for the issue.

19. The system of claim 15, wherein the AI model is stored in a cloud environment hosted by a cloud provider with scalable resources or in a self-hosted environment hosted by a local server.

20. The system of claim 15, wherein the contextual information includes one or more of: environmental parameters of the site, operational constraints, safety regulations, historical issue data, or site-specific protocols.
